(19) United States
(12) Patent Application Publication
(10) Pub. No.: US 2011/0230621 A1
(43) Pub. Date: Sep. 22, 2011

(54) TRANSPARENT SEMI-INTERPENETRATING NETWORK COMPRISING A PHASE OF A LINEAR, NON-CROSSLINKED ISOBUTENE POLYMER

(75) Inventors: Nicole Hildebrandt, Bermersheim (DE); Hannah Maria Koenig, Mannheim (DE); Kristin Tiefensee, Bad Duerkheim (DE); Benjamin Davion, Cergy (FR); Cedric Vancaeyzeele, Vaureal (FR); Odile Fichet, Poissy (FR); Dominique Teyssie, Le Pecq (FR)

(73) Assignee: BASF SE, LUDWIGSHAFEN (DE)

(21) Appl. No.: 13/126,857

(22) PCT Filed: Dec. 9, 2009
(86) PCT No.: PCT/EP09/66767

§ 371 Date: Apr. 29, 2011

(30) Foreign Application Priority Data
Dec. 10, 2008 (EP) 08171226.7

(51) Int. Cl. C08L 33/10; C08L 23/20; C08J 3/24

(52) U.S. Cl. 525/216

(57) ABSTRACT

A transparent, semi-interpenetrating network comprises a first phase of a linear noncrosslinked isobutene polymer and a second phase of a crosslinked polymer. The crosslinked polymer is obtained through copolymerization of a first ethylenically unsaturated monomer and of a second ethylenically unsaturated monomer, wherein the first ethylenically unsaturated monomer is a cycloalkyl(meth)acrylate and the second ethylenically unsaturated monomer is selected from linear and branched C₁-C₂₀ alkyl(meth)acrylates. By varying the ratio of the first ethylenically unsaturated monomer relative to the second ethylenically unsaturated monomer, the properties, such as vibration damping properties, of the semi-interpenetrating network can be controlled.

The invention relates to a semi-interpenetrating network having a first phase of a linear noncrosslinked isobutene polymer and a second phase of a crosslinked polymer.

Linear polyisobutenes are notable for particular properties, such as high gas and moisture barrier effect and high tackifying effect. The gas and moisture barrier effect of the polyisobutenes is exploited, for example, in sealants. Disadvantages exhibited by linear polyisobutenes include a high creep tendency and cold flow, which for many applications are undesirable.

The tackifying effect of the polyisobutenes is exploited in adhesives. Owing to the low level of cohesion of the polyisobutenes, however, the adhesives are not completely satisfactory.

From, for example, Paul D. R. and Barlow J. W., J. Macromol. Sci., Rev. Macromol. Chem., 18, 109 (1980) and Krause S. in “Polymer Blends” 1, 66, Paul D. R. and Newman S. (eds.), Academic Press New York (1978), it is known that polyalkylene polymers and atactic polystyrene are entirely incompatible. Physical mixtures of these polymers are heterogeneous and, because of the poor miscibility, have the two glass transition temperatures of the pure components.

Attempts have been made to mix the polymers at a molecular level and to obtain what are called interpenetrating networks, by swelling a crosslinked polyalkylene polymer with styrene and then polymerizing the styrene in situ. The degree of swelling achievable, however, is restricted, and it is not possible in this way to introduce any polystyrene fractions substantially higher than 10% into the network. Moreover, the associated modification of properties is unstable and disappears on thermal exposure, owing to separation phenomena.

There is an obvious need for transparent polymeric products for a very wide variety of applications, such as the packaging sector, for example.

The earlier application PCT/EP2008/057815 describes a semi-interpenetrating network having a first phase of a linear noncrosslinked isobutene polymer and a second phase of a crosslinked polymer, the crosslinked polymer being obtained by crosslinking molecular enlargement reaction in the presence of the isobutene polymer. It is said that, by selecting monomers having a refractive index similar to that of the isobutene polymer, it is possible to produce transparent semi-interpenetrating networks. For instance, transparent semi-interpenetrating networks are said to be obtained when cyclohexyl methacrylate is used as monomer.

In the case of transparent polymer products, it is often desired to have variations in properties in order to make the products amenable to a new territory of use. In particular it is intended that the mechanical properties can be adapted without adversely affecting the transparency of the products.

In accordance with the invention this object is achieved by means of a semi-interpenetrating network having a first phase of a linear noncrosslinked isobutene polymer and a second phase of a crosslinked polymer, the crosslinked polymer being obtainable by free-radical copolymerization of a first ethylenically unsaturated monomer and of a second ethylenically unsaturated monomer, the first ethylenically unsaturated monomer being a cycloalkyl(meth)acrylate and the second ethylenically unsaturated monomer being selected from linear and branched C₁-C₂₀ alkyl(meth)acrylates, preferably from linear and branched C₆-C₁₈ alkyl(meth)acrylates.

As shown in the examples below, it is possible, by varying the proportion of the first ethylenically unsaturated monomer to the second ethylenically unsaturated monomer, to control the properties, such as the vibration damping, for example, of the semi-interpenetrating network. By varying the weight ratio of the first to the second phase and/or by varying the degree of crosslinking of the second phase, it is possible to carry out further adaptation of the properties of the semi-interpenetrating network to the particular requirements.

A semi-interpenetrating network is a combination of a crosslinked polymer and a linear noncrosslinked polymer where one polymer is synthesized in the presence of the other. Between the two polymer constituents there are substantially no covalent bonds. The noncrosslinked polymer penetrates the network of the crosslinked polymer and has the effect that, as a result of interengagements in the form of hooks and loops, the two components are virtually impossible to separate physically. This semi-interpenetrating network permits the combination of properties of two polymers, in spite of their thermodynamic incompatibility. As compared with common polymer blends, the semi-interpenetrating networks are more resistant to separation and have better mechanical properties. The degradation resistance of the semi-interpenetrating networks is commonly better than that of copolymers in which the incompatible polymers have been bonded to one another covalently in the form of blocks.

In the present invention an isobutene polymer is used as the linear uncrosslinked polymer. The semi-interpenetrating network allows the production of (1) materials which feature high gas and moisture barrier effect without tack and without cold flow, or (2) materials which feature tack and very low cold flow, or (3) materials which feature high gas and moisture barrier effect and tack without cold flow.

The weight ratio of the first to the second phase in the molding compound of the invention is generally 5:95 to 95:5, preferably 5:95 to 80:20, more particularly 30:70 to 70:30.

Compositions with high levels of the crosslinked polymer (e.g., with a weight ratio of the first phase to the second phase of 60:40 to 10:90, preferably 50:50 to 30:70) display substantially no tack and no cold flow. The gas and moisture barrier effect of the polyisobutene is maintained. The compositions are suitable as dimensionally stable sealants or moldings with barrier effect for air and/or water vapor.

In the case of inventive compositions with a high isobutene polymer fraction (e.g., with a weight ratio of the first to the second phase of 60:40 to 90:10, preferably 60:40 to 80:20), the tackifying properties of the polyisobutene are largely retained. The compositions, however, are largely free from cold flow and exhibit improved cohesion as compared with polyisobutene.

Through the presence of the crosslinked second phase it is also possible for moldings to be produced with a high isobutene polymer fraction.

### Isobutene Polymer

The isobutene polymer comprises at least 80%, more particularly at least 90%, and with particular preference at least 95%, and most preferably at least 99%, by weight of isobutene units. Besides isobutene units the isobutene polymer may also comprise units of olefinically unsaturated monomers which are copolymerizable with isobutene. The comonomers may be distributed randomly in the polymer or may be arranged in the form of blocks. Suitable copolymerizable monomers include, in particular, vinylaromatics such as styrene, C₁-C₄ alkylstyrenes such as α-methylstyrene, 3- and 4-methylstyrene or 4-tert-butylstyrene, and also isoolefins having 5 to 10 C atoms, such as 2-methylbut-1-ene, 2-methylpent-1-ene, 2-methylhex-1-ene, 2-ethylpent-1-ene, 2-ethylhex-1-ene, and 2-propylhept-1-ene, or dienes such as isoprene or butadiene.

The isobutene polymer preferably has a number-average molecular weight of 500 to 500 000, more particularly 1000 to 200 000, with particular preference 20 000 to 100 000.

Inventively suitable polyisobutenes and their preparation are described, for example, in U.S. Pat. No. 5,137,980, EP-A-145235, and U.S. Pat. No. 5,068,490. They are obtained generally by cationic polymerization of isobutene. The polymerization takes place with, for example, boron trifluoride catalysis.

Suitable polyisobutenes are available under the name Oppanol® B 10, Oppanol® B 12 or Oppanol® B 15 from BASF Aktiengesellschaft, Ludwigshafen, Germany.

In general, on the basis of its preparation by cationic polymerization, the polyisobutene has an ethylenic unsaturation at one end of the molecule. This ethylenic unsaturation is generally not homopolymerizable or copolymerizable by free-radical polymerization. On free-radical polymerization of ethylenically unsaturated monomers in the presence of the isobutene polymer, therefore, the isobutene polymer plays substantially no part in the reaction. No covalent bonds are formed between the resultant crosslinked polymer and the isobutene polymer. The isobutene polymer has preferably no functional groups (apart from an optional terminal ethylenic unsaturation).

### Crosslinked Polymer

The second phase of the semi-interpenetrating network of the invention is formed by a crosslinked polymer. The crosslinked polymer is obtained by copolymerization of a first ethylenically unsaturated monomer in the form of a cycloalkyl(meth)acrylate and of a second ethylenically unsaturated monomer which is selected from linear and branched C₁-C₂₀ alkyl(meth)acrylates, preferably from linear and branched C₆-C₁₈ alkyl(meth)acrylates.

The copolymerization of the ethylenically unsaturated monomers may be free-radically, anionically or cationically catalyzed. Free-radical copolymerization is generally preferred.

The weight ratio of the first ethylenically unsaturated monomer to the second ethylenically unsaturated monomer is generally 99:1 to 1:99, preferably 90:10 to 10:90, more particularly 80:20 to 20:80.

Cycloalkyl(meth)acrylates comprise a monocyclic or polycyclic cycloalkyl radical which is attached directly or via a C₁-C₄ alkylene group to a (meth)acryloyloxy radical. The cycloalkyl radical may carry, for example, one to four C₁-C₄ alkyl substituents.

Specific examples are cyclopentyl acrylate, cyclopentyl methacrylate, cyclohexyl acrylate, cyclohexyl methacrylate, 4-methylcyclohexyl acrylate, 4-methylcyclohexyl methacrylate, 2,6-dimethylcyclohexyl acrylate, 2,6-dimethylcyclohexyl methacrylate, isobornyl acrylate, isobornyl methacrylate, adamantyl acrylate, adamantyl methacrylate, 3,5-dimethyladamantyl acrylate, and 3,5-dimethyladamantyl methacrylate.

The use of cyclohexyl methacrylate is preferred.

C₁-C₂₀ alkyl(meth)acrylates are alkyl acrylates and methacrylates having 1 to 20 C atoms in the alkyl radical, such as, more particularly, methyl(meth)acrylate, ethyl(meth)acrylate, propyl(meth)acrylate, butyl(meth)acrylate, pentyl(meth)acrylate, hexyl(meth)acrylate, heptyl(meth)acrylate, octyl(meth)acrylate, isooctyl(meth)acrylate, nonyl(meth)acrylate, isononyl(meth)acrylate, decyl(meth)acrylate, isodecyl(meth)acrylate, dodecyl(meth)acrylate, isododecyl(meth)acrylate, tridecyl(meth)acrylate, isotridecylyl(meth)acrylate, lauryl(meth)acrylate, stearyl(meth)acrylate, behenyl(meth)acrylate.

C₆-C₁₈ alkyl(meth)acrylates are preferred.

Of these, hexyl methacrylate, lauryl methacrylate, isodecyl methacrylate, stearyl methacrylate, and mixtures thereof are preferred.

It is possible also to use a small fraction, up to 2% by weight for example, based on the total amount of the monomers, of water-soluble or hydrophilic monomers. Water-soluble monomers are, for example, (meth)acrylic acid, (meth)acrylamide. Hydrophilic monomers are in particular those which possess a hydroxyl and/or amino group, such as 2-hydroxyethyl(meth)acrylate, 2-hydroxypropyl(meth)acrylate, butanediol mono(meth)acrylate, and dimethylaminoethyl(meth)acrylates.

It is preferred to use monomer mixtures which produce a copolymer having a glass transition temperature of more than −70° C., preferably more than +20° C., and more preferably more than +50° C.

Preference is given to using monomer mixtures which produce a polymer or copolymer having a solubility parameter which differs from that of the isobutene polymer by less than 1 MPa^{1/2}, preferably less than 0.7 MPa^{1/2}, more particularly less than 0.5 MPa^{1/2}. With a small difference between the solubility parameters of the isobutene polymer and of the crosslinked polymer, the mutual compatibility of the polymers is high and the extractable fraction of the network is low. From this standpoint, the accompanying use of cyclohexyl methacrylate (polycyclohexyl methacrylate/polystyrene solubility parameter difference=0.20 MPa^{1/2}) is particularly preferred.

The calculation method (incremental method of Hoftyzer-van Krevelen) and experimentally determined values for the solubility parameters are elucidated in U.S. Pat. No. 6,362,274 B1, J. Applied Polym. Sci. 2000, 78, 639, and in the following monograph: D. W. van Krevelen, “Properties of polymers. Their correlation with chemical structure; their numerical estimation and prediction from additive group contributions”, 3rd edition, Elsevier, 1990, pp. 189-225.

The above monoethylenically unsaturated monomers may be polymerized together with polyethylenically unsaturated monomers, so as to give a crosslinked polymer.

The polyethylenically unsaturated monomers include compounds which have at least two nonconjugated, ethylenically unsaturated double bonds, examples being the diesters of dihydric alcohols with α,β-monoethylenically unsaturated C₃-C₁₀ monocarboxylic acids. Examples of compounds of this kind are alkylene glycol diacrylates and dimethacrylates, such as ethylene glycol diacrylate, ethylene glycol dimethacrylate, 1,3-butylene glycol diacrylate, 1,3-butylene glycol dimethacrylate, 1,4-butanediol diacrylate, 1,4-butanediol dimethacrylate, propylene glycol diacrylate, propylene glycol dimethacrylate polyethylene glycol di(meth)acrylate, divinylbenzene, vinyl acrylate, vinyl methacrylate, allyl acrylate, allyl methacrylate, diallyl maleate, diallyl fumarate, methylenebisacrylamide, cyclopentadienyl acrylate, tricyclodecenyl (meth)acrylate, N,N′-divinylimidazolin-2-one or triallyl cyanurate.

Ethylene glycol diacrylate and 1,4-butanediol diacrylate are preferred polyethylenically unsaturated monomers.

The crosslinking monomers may additionally be, for example, epoxide or urethane (meth)acrylates.

Epoxide (meth)acrylates are, for example, those of the kind obtainable by reacting polyglycidyl or diglycidyl ethers, such as bisphenol A diglycidyl ether, with (meth)acrylic acid.

The reaction is known to the skilled worker and described, for example, in R. Holmann, U.V. and E.B. Curing Formulation for Printing Inks and Paints, London 1984.

Urethane (meth)acrylates are more particularly reaction products of hydroxyalkyl(meth)acrylates with polyisocyanates and/or diisocyanates (see likewise R. Holmann, U.V. and E.B. Curing Formulation for Printing Inks and Paints, London 1984).

The urethane (meth)acrylates also include the reaction products of hydroxyalkyl (meth)acrylates with isocyanurates. Preferred isocyanurates are those of the typical diisocyanates. Mention may be made more particularly of diisocyanates X(NCO)₂, wherein X is an aliphatic hydrocarbon radical having 4 to 15 carbon atoms, a cycloaliphatic or aromatic hydrocarbon radical having 6 to 15 carbon atoms or an araliphatic hydrocarbon radical having 7 to 15 carbon atoms. Examples of such diisocyanates are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)-propane, trimethylhexane diisocyanate, 1,4-diisocyanatobenzene, 2,4-diisocyanato-toluene, 2,6-diisocyanatotoluene, 4,4′-diisocyanatodiphenylmethane, 2,4′-diiso-cyanatodiphenylmethane, p-xylylene diisocyanate, tetramethylxylylene diisocyanate (TMXDI), the isomers of the bis(4-isocyanatocyclohexyl)methane (HMDI) such as the trans/trans, the cis/cis, and the cis/trans isomers, and mixtures of these compounds. The crosslinking monomers are used typically in an amount of 0.1 to 100 mol %, e.g., 0.1 to 30 mol %, preferably 1 to 20 mol %, more particularly 3 to 10 mol %, based on the total amount of the constituent monomers.

Optionally it is also possible to use aftercrosslinking monomers as well. The crosslinking-active sites of the aftercrosslinking monomers do not take part in the molecular enlargement reaction, but may be selectively aftercrosslinked in a later step. Examples of suitable aftercrosslinking monomers include glycidyl methacrylate, acrylamidoglycolic acid, methyl methylacrylamidoglycolate, N-methylolacrylamide, N-methylolmethacrylamide, N-methylol allyl carbamate, alkyl ethers and esters of N-methylolacrylamide and also of N-methylolmethacrylamide and of N-methylol allyl carbamate, and also acryloyloxypropyltri(alkoxy)silanes and methacryloyloxypropyltri-(alkoxy)silanes, vinyltrialkoxysilanes, and vinylmethyldialkoxysilanes.

The amount of the crosslinking monomers is chosen so as to give a desired degree of crosslinking. The degree of crosslinking is defined as the amount of substance (in mol) of crosslinkers divided by the amount of substance (in mol) of the total monomers present. The degree of crosslinking is preferably 1% to 20%, more particularly 3% to 10%.

The polymerization is initiated preferably by means of a free-radical-forming initiator and/or by high-energy radiation such as UV radiation or electron beams. It is also possible to use redox initiator couples which comprise an oxidant and a reductant. The initiator is used typically in an amount of 0.1% to 2% by weight, based on the total amount of the monomers of the crosslinked polymer. Suitable initiators from the class of the peroxide compounds, azo compounds or azo peroxide compounds are known to the skilled worker and are available commercially.

Examples of suitable initiators that may be listed include di-tert-butyl oxypivalate, didecanoyl peroxide, dilauroyl peroxide, diacetyl peroxide, di-tert-butyl peroctoate, dibenzoyl peroxide, tert-butyl peracetate, tert-butyl peroxyisopropyl carbonate, tert-butyl perbenzoate, di-tert-butyl peroxide, 1,1-bis(tert-butylperoxy)-3,3,5-trimethyl-cyclohexane, 2,5-dimethyl-2,5-bis(benzoylperoxy)hexane, 1,4-di(tert-butylperoxy-carbonyl)cyclohexane, 1,1-bis(tert-butylperoxy)cyclohexane, di-tert-butyl diperoxy-azelate, or di-tert-butyl peroxycarbonate. Among these, dilauroyl peroxide, dibenzoyl peroxide, tert-butyl perbenzoate, and tert-butyl peroxyisopropyl carbonate are preferred.

An example of a suitable azo initiator is azoisobutyronitrile (AIBN).

In certain embodiments a photoinitiator is used.

The photoinitiator may comprise, for example, what are known as a splitters, in other words photoinitiators in which a chemical bond is split, forming 2 free radicals which initiate the further crosslinking or polymerization reactions.

Mention may be made, for example, of acylphosphine oxides (Lucirin® products from BASF), hydroxyalkylphenones (e.g., Irgacure® 184), benzoin derivatives, benzil derivatives, and dialkyloxyacetophenones.

More particularly the photoinitiator may comprise what are known as H abstractors, which detach a hydrogen atom from the polymer chain; examples include photoinitiators with a carbonyl group. This carbonyl group is inserted into a C—H bond to form a C—C—O—H moiety.

Here mention may be made more particularly of acetophenone, benzophenone, and their derivatives.

It is possible to use both classes of photoinitiators alone or else in a mixture.

The thermal polymerization takes place typically at an elevated temperature, a suitable temperature range being from 40 to 180° C., preferably 60 to 120° C. With advantage it is also possible to increase the temperature in stages. Where the polymerization is initiated by high-energy radiation, lower temperatures are also suitable, ambient temperature for example.

The polymerization may take place in a variety of ways. Typically it takes place as a bulk polymerization, solution polymerization, emulsion polymerization or miniemulsion polymerization.

Solvents may be used as well if appropriate. In the case of low to medium fractions, as for example where the weight ratio of the first phase to the second phase is up to 70:30, the synthesis may take place in the absence of solvent if the isobutene polymer is soluble in the precursors of the crosslinked polymer, e.g., the constituent monomers. The monomers act as reactive solvents. To reduce the viscosity of the reaction mixture it may nevertheless be advantageous to use a solvent as well. At weight ratios of the first phase to the second phase of more than 70:30, or if the isobutene polymer is not soluble, or not sufficiently, in the precursors of the crosslinked polymer, the addition of a solvent is generally unavoidable.

Suitability for this purpose is possessed by saturated or unsaturated aliphatic hydrocarbons such as hexane, pentane, isopentane, cyclohexane, methylcyclohexane, diisobutene, triisobutene, tetraisobutene, pentaisobutene, hexaisobutene or mixtures thereof, aromatic hydrocarbons such as benzene, toluene, xylene, halogenated hydrocarbons, such as dichloromethane or trichloromethane, or mixtures thereof.

The polymerization can also be carried out in the presence of a plasticizer or a mixture of plasticizers, such as the phthalates and adipates of aliphatic or aromatic alcohols, examples being di(2-ethylhexyl)adipate, di(2-ethylhexyl)phthalate, diisononyl adipate or diisononyl phthalate.

An example of a procedure for producing the network of the invention is to dissolve or disperse the isobutene polymer in the ethylenically unsaturated monomers, optionally with addition of a solvent, to introduce the solution or dispersion into a casting mold, and to initiate the copolymerization, by means of a temperature increase or high-energy radiation, for example. After the network has formed, the material can be demolded.

An alternative procedure is to convert the solution or dispersion into a plastic state by adding fillers and/or thickeners. The plastic composition can then be shaped into any desired form. Shaping may take place advantageously by extrusion through a shaping die. In this way it is easy to produce sealing profiles, for example. The form of the shaped composition is then fixed by initiation of the copolymerization.

Alternatively it is possible to prepare a solution or dispersion and to initiate the copolymerization, the degree of crosslinking being set such that the network obtained primarily is still shapeable. The network obtained primarily can then be shaped, optionally following addition of fillers, into any desired form. The form of the shaped composition is then fixed by aftercrosslinking. The aftercrosslinking can be achieved by temperature increase, high-energy radiation and/or suitable catalysts or the like. Aftercrosslinking is made easier if, in the copolymerization, the monomers used include aftercrosslinking monomers, whose aftercrosslinking-active sites do not take part in the copolymerization and can be selectively aftercrosslinked after the copolymerization and shaping.

The compositions of the invention may further comprise typical auxiliaries which are typical for the application in question. These include, for example, fillers, diluents or stabilizers.

In preferred embodiments active compounds or effect substances are incorporated into the semi-interpenetrating networks of the invention. Suitable active compounds are biocides, for example; suitable effect substances are dyes. The active compounds or effect substances are generally not miscible with pure polyisobutene, but are soluble or dispersible in the semi-interpenetrating network or can be anchored covalently in the crosslinked polymer. The invention therefore for the first time shows a way of combining the properties of isobutene polymers with the properties of the active compounds and effect substances.

Examples of suitable fillers include silica, including colloidal silica, calcium carbonate, carbon black, titanium dioxide, mica, quartz, glass fibers and glass beads, and the like.

Examples of suitable diluents include polybutene, liquid polybutadiene, hydrogenated polybutadiene, liquid paraffin, naphthenates, atactic polypropylene, dialkyl phthalates, reactive diluents, e.g., alcohols, and oligoisobutenes.

Examples of suitable stabilizers include 2-benzothiazolyl sulfide, benzothiazole, thiazole, dimethyl acetylenedicarboxylate, diethyl acetylenedicarboxylate, butylated hydroxytoluene (BHT), butylated hydroxyanisole, and vitamin E.

In accord with the invention the semi-interpenetrating network may be produced as a planar structure, more particularly a film, in which case a composition which comprises a linear noncrosslinked isobutene polymer and polyfunctional resin precursors and/or monomers together with at least one crosslinking agent is applied to a support and in the composition a copolymerization is initiated.

The copolymerization is initiated preferably thermally or by high-energy radiation, more particularly by UV light. In the case of initiation by high-energy radiation the composition preferably comprises at least one photoinitiator. The coated support is irradiated with high-energy light, preferably UV light, in order to achieve the desired crosslinking. The radiation energy may amount, for example, to 10 mJ/cm² to 1500 mJ/cm² of irradiated area.

The support material may be a temporary support, from which the planar structure is removed again following production or immediately prior to use, such as a roller, a release sheet of paper, which may have been siliconized, or a polymeric film, comprising polyolefins or PVC, for example.

Application to the support may take place by known techniques, such as by roller application, knifecoating, dipping or the like, for example. The amount applied may in particular be 10 to 300 g, preferably 10 to 150 g, and typically often 20 to 80 g per square meter of support.

The materials of the invention are suitable for the applications below. Depending on the end application, preformed semi-interpenetrating networks (in the form, for example, of sheets) are employed or the semi-interpenetrating network is obtained in situ from a noncrosslinked semi-IPN:
Sealants for windows or doors. The semi-interpenetrating network of the invention can be used at higher temperatures than pure PIB in the window sealing segment without any exudation occurring.
Sealing material for the sanitary segment. The noncrosslinked semi-IPN is introduced and polymerized/crosslinked in situ, in order to produce watertight sealants adhering well to building materials. The sealants inhibit infestation by fungi or bacteria. Compositions of this kind could be used to replace moisture-crosslinking silicone systems.
Antifouling coatings, which reduce or prevent colonization by microorganisms, such as bacteria or algae.
Watertight sheeting, for lining boreholes and cavities in geological formations into which combustion residues, for example, are placed, for example.
Materials or moldings for the roofing of buildings, in the form of sheet webs or panels.
Polymer films for glass coating. Films of the semi-interpenetrating network of the invention can be adhered flatly to glass surfaces, more particularly panes of glass. These films serve for protection from radiation or impart color to the pane of glass (autoglass tinting).
Ultrathin films which are applied for the purpose of protection from moss, algae or mold to articles such as sculptures, paintings, old books or monuments.
Adhesives with high tack at the contact faces and high cohesion internally. It is supposed that there is a certain phase separation, with the consequence that isobutene polymer emerges on the outer surfaces. The isobutene polymer penetrates the microscopic surface unevennesses and cavities of the surfaces to be bonded. This ensures effective wetting of the surfaces and adhesion. Within the adhesive, the network brings about structural integrity and hence high cohesion of the composition. The adhesives can be formulated so as to be transparent. They exhibit advantages over dispersion-based adhesives, which can become cloudy on contact with water.
Adhesives for hydrophobic surfaces, such as plastics.
Adhesives for glass surfaces, examples being double glazing adhesives/safety glass. Safety glass is constructed from a glass/polymer sheet/glass sandwich setup. The sheet used is conventionally polyvinyl butyral. The adhesive properties and the mechanical reinforcement can also be achieved with sheets of semi-interpenetrating networks of the invention.
Adhesives for what are called 100% systems, where the curing of the adhesive is accomplished, following application, by later crosslinking.
Insulator layers for the electronics industry. Semi-interpenetrating networks of the invention permit the use of PIB in the electronics industry for the watertight sealing/packaging of electronic components, in order to prevent short circuits, corrosion, etc.

This enumeration of the potential applications is not conclusive.

The invention is illustrated in more detail by the attached figures and the examples which follow.

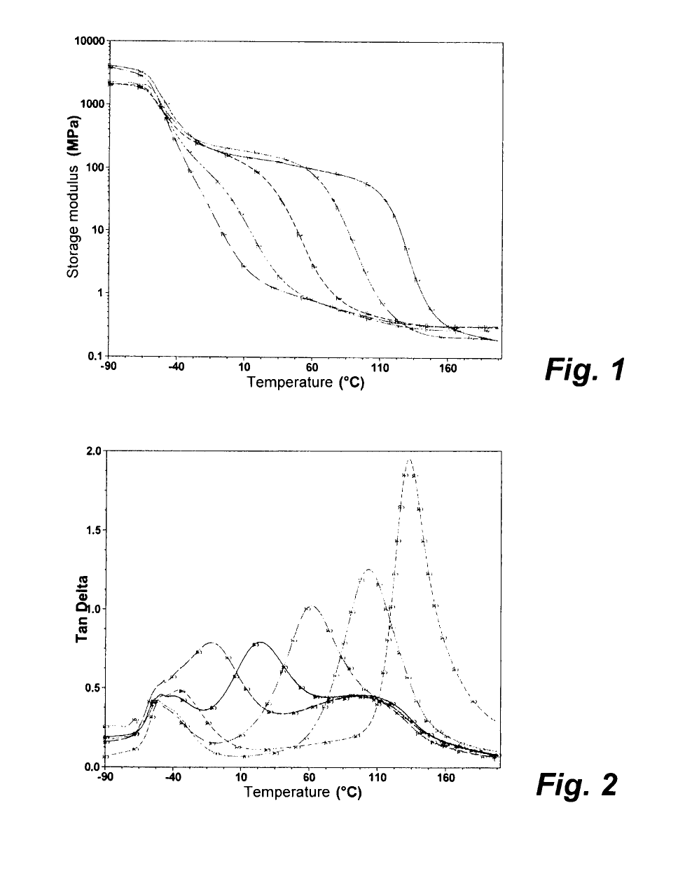

FIG. 1 shows the storage modulus as a function of the temperature for semi-IPNs of PIB in crosslinked (co)polymers (weight ratio PIB:(co)polymer 50/50); from left: lauryl methacrylate homopolymer; lauryl methacrylate-cyclohexyl methacrylate copolymers 25-co-75; 50-co-50; 75-co-25; cyclohexyl methacrylate homopolymer;

FIG. 2 shows the loss factor (tan δ) as a function of the temperature for semi-IPNs of PIB in crosslinked (co)polymers (50/50); from left: lauryl methacrylate homopolymer; lauryl methacrylate-cyclohexyl methacrylate copolymers 25-co-75; 50-co-50; 75-co-25; cyclohexyl methacrylate homopolymer.

### EXAMPLES

The abbreviations used in the examples below are as follows:

semi-IPN=semi-interpenetrating network

CHMA=cyclohexyl methacrylate
HMA=hexyl methacrylate
LMA=lauryl methacrylate
iDMA=isododecyl methacrylate
SMA=stearyl methacrylate
PIB=polyisobutene
P(CHMA-co-XX)=copolymer of cyclohexyl methacrylate and monomer XX

In the examples, Oppanol B15SFN was used as the polyisobutene. This is a polyisobutene having a molecular weight of 85 000 g/mol (viscosity average).

The thermomechanical properties of the semi-IPNs were measured using a DMTA Q800 thermomechanical dynamic analyzer from TA Instruments, New Castle, Del. (USA). The conditions were as follows: loading=0.05%; frequency=1 Hz; heating ramp=3° C./min.

### Example 1

### PIB/P(CHMA-co-HMA 25-co-75) 50/50 Semi-IPN

2 g of PIB were dissolved with mechanical stirring in 0.5 g of cyclohexyl methacrylate, 1.5 g of hexyl methacrylate, 0.12 g of ethylene glycol dimethacrylate, and 0.06 g of benzoyl peroxide. As soon as a homogeneous, viscous solution was obtained, it was poured into a glass casting mold with a 1 mm Teflon seal. The synthesis batch was cured at 80° C. for 25 minutes and at 100° C. for 5 minutes. This gave a transparent material.

The semi-IPN shows two mechanical relaxations at −50° C. and 58° C., which are characteristic for the PIB phase and for the P(CHMA-co-HMA 25-co-75) phase, respectively. The PIB/P(CHMA-co-HMA 25-co-75) 50/50 semi-IPN has a storage modulus at 20° C. of 73 MPa and exhibits no cold flow even at a high temperature (up to 200° C.).

### Example 2

### PIB/P(CHMA-co-HMA 25-co-75) 70/30 Semi-IPN

The semi-IPN was synthesized under the same experimental conditions (same molar ratios of crosslinker and initiator, in relation to cyclohexyl methacrylate and hexyl methacrylate) as in the preceding example.

### Example 3

### PIB/P(CHMA-co-HMA 50-co-50) 50/50 Semi-IPN)

2 g of PIB were dissolved with mechanical stirring in 1.0 g of cyclohexyl methacrylate, 1 g of hexyl methacrylate, 0.12 g of ethylene glycol dimethacrylate, and 0.06 g of benzoyl peroxide. As soon as a homogeneous, viscous solution was obtained, it was poured into a glass casting mold with a 1 mm Teflon seal. The synthesis batch was cured at 80° C. for 25 minutes and at 100° C. for 5 minutes. This gave a transparent material.

The semi-IPN shows two mechanical relaxations at −50° C. and 85° C., which are characteristic for the PIB phase and for the P(CHMA-co-HMA 50-co-50) phase, respectively. The PIB/P(CHMA-co-HMA 50-co-50) 50/50 semi-IPN has a storage modulus at 20° C. of 167 MPa and exhibits no cold flow even at a high temperature (up to 200° C.).

### Example 4

### I PIB/P(CHMA-co-HMA 50-co-50) 70/30 Semi-IPN

The semi-IPN was synthesized under the same experimental conditions (same molar ratios of crosslinker and initiator, in relation to cyclohexyl methacrylate and hexyl methacrylate) as in the preceding example.

### Example 5

### PIB/P(CHMA-co-HMA 75-co-25) 50/50 Semi-IPN

2 g of PIB were dissolved with mechanical stirring in 1.5 g of cyclohexyl methacrylate, 0.5 g of hexyl methacrylate, 0.12 g of ethylene glycol dimethacrylate, and 0.06 g of benzoyl peroxide. As soon as a homogeneous, viscous solution was obtained, it was poured into a glass casting mold with a 1 mm Teflon seal. The synthesis batch was cured at 80° C. for 25 minutes and at 100° C. for 5 minutes. This gave a transparent material.

The semi-IPN shows two mechanical relaxations at −50° C. and 117° C., which are characteristic for the PIB phase and for the P(CHMA-co-HMA 75-co-25) phase, respectively. The PIB/P(CHMA-co-HMA 75-co-25) 50/50 semi-IPN has a storage modulus at 20° C. of 182 MPa and exhibits no cold flow even at a high temperature (up to 200° C.).

### Example 6

### PIB/P(CHMA-co-HMA 75-co-25) 70/30 Semi-IPN

The semi-IPN was synthesized under the same experimental conditions (same molar ratios of crosslinker and initiator, in relation to cyclohexyl methacrylate and hexyl methacrylate) as in the preceding example.

### Example 7

### PIB/P(CHMA-co-LMA 25-co-75) 50/50 Semi-IPN

2 g of PIB were dissolved with mechanical stirring in 0.5 g of cyclohexyl methacrylate, 1.5 g of lauryl methacrylate, 0.09 g of ethylene glycol dimethacrylate, and 0.04 g of benzoyl peroxide. As soon as a homogeneous, viscous solution was obtained, it was poured into a glass casting mold with a 1 mm Teflon seal. The synthesis batch was cured at 80° C. for 25 minutes and at 100° C. for 5 minutes. This gave a transparent material.

The semi-IPN shows two mechanical relaxations at −50° C. and 24° C., which are characteristic for the PIB phase and for the P(CHMA-co-LMA 25-co-75) phase, respectively. The PIB/P(CHMA-co-LMA 25-co-75) 50/50 semi-IPN has a storage modulus at 20° C. of 6 MPa and exhibits no cold flow even at a high temperature (up to 200° C.).

### Example 8

### PIB/P(CHMA-co-LMA 25-co-75) 70/30 Semi-IPN

The semi-IPN was synthesized under the same experimental conditions (same molar ratios of crosslinker and initiator, in relation to cyclohexyl methacrylate and lauryl methacrylate) as in the preceding example.

### Example 9

### PIB/P(CHMA-co-LMA 50-co-50) 50/50 Semi-IPN

2 g of PIB were dissolved with mechanical stirring in 1 g of cyclohexyl methacrylate, 1 g of lauryl methacrylate, 0.1 g of ethylene glycol dimethacrylate, and 0.05 g of benzoyl peroxide. As soon as a homogeneous, viscous solution was obtained, it was poured into a glass casting mold with a 1 mm Teflon seal. The synthesis batch was cured at 80° C. for 25 minutes and at 100° C. for 5 minutes. This gave a transparent material.

The semi-IPN shows two mechanical relaxations at −50° C. and 61° C., which are characteristic for the PIB phase and for the P(CHMA-co-LMA 50-co-50) phase, respectively. The PIB/P(CHMA-co-LMA 50-co-50) 50/50 semi-IPN has a storage modulus at 20° C. of 83 MPa and exhibits no cold flow even at a high temperature (up to 200° C.).

### Example 10

### PIB/P(CHMA-co-LMA 25-co-75) 70/30 Semi-IPN

The semi-IPN was synthesized under the same experimental conditions (same molar ratios of crosslinker and initiator, in relation to cyclohexyl methacrylate and lauryl methacrylate) as in the preceding example.

### Example 11

### PIB/P(CHMA-co-LMA 75-co-25) 50/50 semi-IPN

2 g of PIB were dissolved with mechanical stirring in 0.5 g of cyclohexyl methacrylate, 1.5 g of lauryl methacrylate, 0.11 g of ethylene glycol dimethacrylate, and 0.05 g of benzoyl peroxide. As soon as a homogeneous, viscous solution was obtained, it was poured into a glass casting mold with a 1 mm Teflon seal. The synthesis batch was cured at 80° C. for 25 minutes and at 100° C. for 5 minutes. This gave a transparent material.

The semi-IPN shows two mechanical relaxations at −50° C. and 103° C., which are characteristic for the PIB phase and for the P(CHMA-co-LMA 75-co-25) phase, respectively. The PIB/P(CHMA-co-LMA 75-co-25) 50/50 semi-IPN has a storage modulus at 20° C. of 171 MPa and exhibits no cold flow even at a high temperature (up to 200° C.).

### Example 12

### PIB/P(CHMA-co-LMA 75-co-25) 70/30 Semi-IPN

The semi-IPN was synthesized under the same experimental conditions (same molar ratios of crosslinker and initiator, in relation to cyclohexyl methacrylate and lauryl methacrylate) as in the preceding example.

### Example 13

### PIB/P(CHMA-co-iDMA 50-co-50) 50/50 Semi-IPN

2 g of PIB were dissolved with mechanical stirring in 1 g of cyclohexyl methacrylate, 1 g of isodecyl methacrylate, 0.1 g of ethylene glycol dimethacrylate, and 0.05 g of benzoyl peroxide. As soon as a homogeneous, viscous solution was obtained, it was poured into a glass casting mold with a 1 mm Teflon seal. The synthesis batch was cured at 80° C. for 25 minutes and at 100° C. for 5 minutes. This gave a transparent material.

The semi-IPN shows two mechanical relaxations at −50° C. and 78° C., which are characteristic for the PIB phase and for the P(CHMA-co-iDMA 50-co-50) phase, respectively. The PIB/P(CHMA-co-iDMA 50-co-50) 50/50 semi-IPN has a storage modulus at 20° C. of 114 MPa and exhibits no cold flow even at a high temperature (up to 200° C.).

### Example 14

### PIB/P(CHMA-co-iDMA 50-co-50) 70/30 Semi-IPN

The semi-IPN was synthesized under the same experimental conditions (same molar ratios of crosslinker and initiator, in relation to cyclohexyl methacrylate and isodecyl methacrylate) as in the preceding example.

### Example 15

### PIB/P(CHMA-co-SMA 50-co-50) 50/50 Semi-IPN

2 g of PIB were dissolved with mechanical stirring in 1 g of cyclohexyl methacrylate, 1 g of stearyl methacrylate, 0.09 g of ethylene glycol dimethacrylate, and 0.04 g of benzoyl peroxide. As soon as a homogeneous, viscous solution was obtained, it was poured into a glass casting mold with a 1 mm Teflon seal. The synthesis batch was cured at 80° C. for 25 minutes and at 100° C. for 5 minutes. This gave a transparent material.

The semi-IPN shows two mechanical relaxations at −50° C. and 58° C., which are characteristic for the PIB phase and for the P(CHMA-co-SMA 50-co-50) phase, respectively. The PIB/P(CHMA-co-SMA 50-co-50) 50/50 semi-IPN has a storage modulus at 20° C. of 38 MPa and exhibits no cold flow even at a high temperature (up to 160° C.).

1. A semi-interpenetrating network, comprising:
a first phase of a linear noncrosslinked isobutene polymer; and
a second phase of a crosslinked polymer,
wherein the crosslinked polymer is obtained by copolymerizing a first ethylenically unsaturated monomer and a second ethylenically unsaturated monomer, and
wherein the first ethylenically unsaturated monomer is a cycloalkyl(meth)acrylate and the second ethylenically unsaturated monomer is at least one selected from the group consisting of a linear C₁-C₁₀ alkyl(meth)acrylate and a branched C₁-C₂₀ alkyl(meth)acrylate.

2. The network of claim 1, wherein the first ethylenically unsaturated monomer is cyclohexyl methacrylate.

3. The network of claim 1, wherein the second ethylenically unsaturated monomer is at least one C₆-C₁₈ alkyl(meth)acrylate.

4. The network of claim 1, wherein the second ethylenically unsaturated monomer is at least one selected from the group consisting of hexyl methacrylate, lauryl methacrylate, isodecyl methacrylate, and stearyl methacrylate.

5. The network of claim 1, wherein the crosslinked polymer is obtained by copolymerization in the presence of a polyethylenically unsaturated monomer.

6. The network of claim 5, wherein the polyethylenically unsaturated monomer is selected from the group consisting of ethylene glycol dimethacrylate and 1,4-butanediol dimethacrylate.

7. The network of claim 1, wherein a weight ratio of the first ethylenically unsaturated monomer to the second ethylenically unsaturated monomer is in a range of 90:10 to 10:90.

8. The network of claim 1, wherein monomers producing the crosslinked polymer has a solubility parameter which differs from that of the linear uncrosslinked isobutene polymer by less than 1 MPa^{1/2}.

9. The network of claim 1, wherein a degree of crosslinking of the crosslinked polymer is 1% to 20%.

10. The network of claim 1, wherein a weight ratio of the first phase to the second phase is 5:95 to 95:5.

11. The network of claim 1, wherein the linear noncrosslinked isobutene polymer has a number-average molecular weight of 500 to 500 000.

12. A molding compound, an adhesive, or sealant, comprising the network of claim 1, wherein the molding compound has a gas and moisture barrier effect.

13. A process for preparing the semi-interpenetrating network of claim 1, comprising subjecting the first ethylenically unsaturated monomer, the second ethylenically unsaturated monomer, and a polyethylenically unsaturated monomer to free-radical polymerization in the presence of the linear noncrosslinked isobutene polymer.

14. The network of claim 2, wherein the second ethylenically unsaturated monomer is at least one C₆-C₁₈ alkyl(meth)acrylate.

15. The network of claim 2, wherein the second ethylenically unsaturated monomer is at least one selected from the group consisting of hexyl methacrylate, lauryl methacrylate, isodecyl methacrylate, and stearyl methacrylate.

16. The network of claim 3, wherein the second ethylenically unsaturated monomer is at least one selected from the group consisting of hexyl methacrylate, lauryl methacrylate, isodecyl methacrylate, and stearyl methacrylate.

17. The network of claim 2, wherein the crosslinked polymer is obtained by copolymerization in the presence of a polyethylenically unsaturated monomer.

18. The network of claim 3, wherein the crosslinked polymer is obtained by copolymerization in the presence of a polyethylenically unsaturated monomer.

19. The network of claim 4, wherein the crosslinked polymer is obtained by copolymerization in the presence of a polyethylenically unsaturated monomer.

20. The network of claim 2, wherein a weight ratio of the first ethylenically unsaturated monomer to the second ethylenically unsaturated monomer is in a range of 90:10 to 10:90.
